(19) United States
(12) Patent Application Publication
(10) Pub. No.: US 2015/0163554 A1
(43) Pub. Date: Jun. 11, 2015

(54) METHOD, ELECTRONIC DEVICE, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventors: Tomomi NISHIGUCHI, Tokyo (JP); Kenji ODAKA, Tokyo (JP)

(21) Appl. No.: 14/468,115

(22) Filed: Aug. 25, 2014

(30) Foreign Application Priority Data
Dec. 10, 2013 (JP) 2013-255242

(51) Int. Cl. H04N 21/482; H04N 21/84; H04N 21/466; H04N 21/258; H04N 21/45; H04N 5/445; H04N 21/431

(52) U.S. Cl. CPC H04N 21/4826; H04N 5/44543; H04N 21/84; H04N 21/4821; H04N 21/4312; H04N 21/25891; H04N 21/4532; H04N 21/4667; H04N 2005/44556

(57) ABSTRACT

According to one embodiment, a method includes: acquiring a first list that includes a plurality of first programs; acquiring first information configured to allow identification of whether each of the first programs in the first list has been viewed; and displaying on a display simultaneously the first programs and the first information.

### CROSS-REFERENCE TO RELATED APPLICATIONS

This application is based upon and claims the benefit of priority from Japanese Patent Application No. 2013-255242, filed Dec. 10, 2013, the entire contents of which are incorporated herein by reference.

### FIELD

Embodiments described herein relate generally to a method, an electronic device, and a computer program product.

### BACKGROUND

Conventionally, there has been known a technique to display a list of a plurality of related programs, each of the related programs being related to each other. One example of the related programs is a serial broadcast in a series.

In the above conventional technique, it is desirable to at-a-glance determination of whether each of the programs registered in the list has been viewed, for example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an entire configuration of a program recommendation system comprising a television according to an embodiment;

FIG. 2 is an exemplary diagram of a related program list used in the program recommendation system in the embodiment;

FIG. 3 is an exemplary block diagram of an internal configuration of the television in the embodiment;

FIG. 4 is an exemplary block diagram of a functional configuration of a controller in the television in the embodiment;

FIG. 5 is an exemplary diagram of a home screen displayed on the television in the embodiment;

FIG. 6 is an exemplary diagram of a my-page screen displayed on the television in the embodiment;

FIG. 7 is an exemplary diagram of the related program list and a check list displayed on the television in the embodiment;

FIG. 8 is an exemplary diagram of the related program list, the check list, and recommended information displayed on the television in the embodiment;

FIG. 9 is an exemplary diagram of a message displayed on the television and indicating that the check list satisfies a predetermined condition, in the embodiment;

FIG. 10 is an exemplary diagram of a broadcast program guide displayed on the television in the embodiment;

FIG. 11 is an exemplary sequence diagram of steps performed by the entire program recommendation system to display the related program list and the check list on the television in the embodiment;

FIG. 12 is an exemplary flowchart of steps performed by the television to display the recommended information on the television in the embodiment; and

FIG. 13 is an exemplary flowchart of steps performed by the television to display the message indicating that the checklist satisfies a predetermined condition on the television in the embodiment.

### DETAILED DESCRIPTION

In general, according to one embodiment, a method comprises: acquiring a first list that comprises a plurality of first programs; acquiring first information configured to allow identification of whether each of the first programs in the first list has been viewed; and displaying on a display simultaneously the first programs and the first information.

An embodiment will be described below with reference to the accompanying drawings.

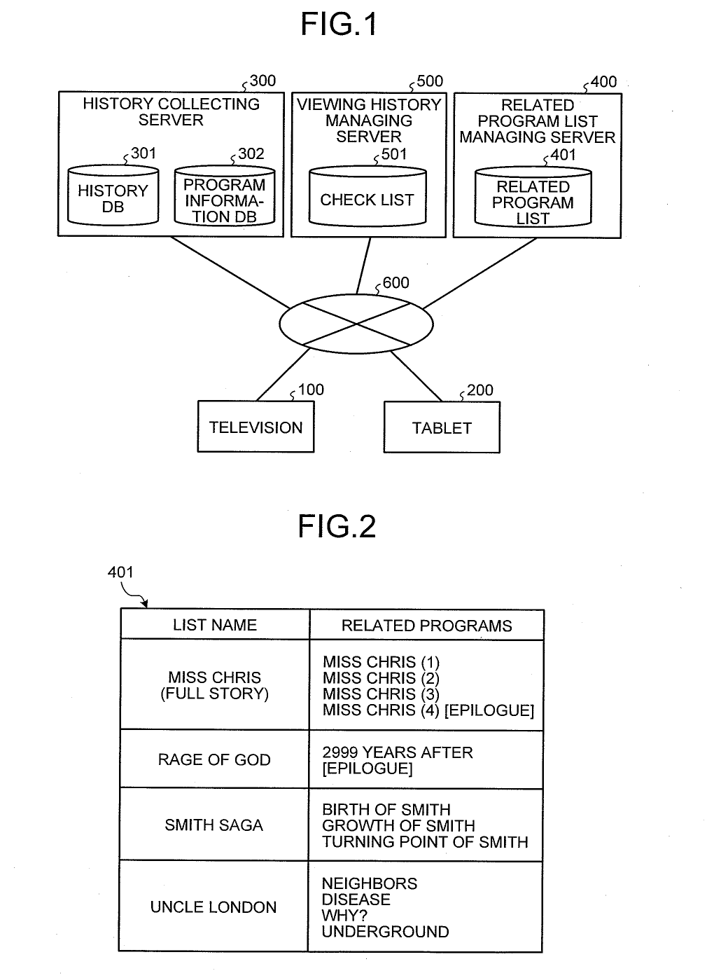

The following describes an exemplary configuration of a program recommendation system 1000 that comprises a television 100 according to an embodiment with reference to FIGS. 1 to 10. The television 100 is one example of an “electronic device”. It is noted that the technique to be described hereunder can also be applied to any electronic devices (e.g., video recording and playing back devices, information processors) other than the television 100.

As illustrated in FIG. 1, the program recommendation system 1000 comprises the television 100, a tablet 200, a history collecting server 300, a related program list managing server 400, and a viewing history managing server 500. These elements are connected to each other via a network 600 such as the Internet.

The television 100 in the embodiment is what is called a smart TV device that is configured to be capable of executing computer programs and services provided by external devices such as cloud servers on the network 600, in addition to broadcast programs. Similar to the television 100, the tablet 200 is configured to be capable of executing the computer programs and services provided by external devices such as cloud servers on the network 600.

The history collecting server 300 has a history database (DB) 301 and a program information DB 302. The history collecting server 300 collects an operation history of users from the television 100 and the tablet 200 and registers the collected operation history in the history DB 301 by users. The “operation history” as used herein refers to a history of operations performed for viewing programs (or content), the operations including an operation for recording a broadcast program, an operation for viewing a broadcast program live (on a real-time basis), and an operation for playing back a recorded program or video-on-demand (VOD) content.

Based on the operation history collected as described above and the program information DB 302, the history collecting server 300 identifies at least one program (viewed program) that has been viewed or played back by the user of the television 100 or the tablet 200. Information on various programs is registered in the program information DB 302. The history collecting server 300 transmits a list of the viewed programs to the viewing history managing server 500 in response to a request from the viewing history managing server 500.

The related program list managing server 400 manages a related program list 401 (see FIG. 2) that gives a list of related programs related to each other. The related program list 401 is one example of a “first list”. The related program list managing server 400 transmits the related program list 401 to the viewing history managing server 500 in response to a request from the viewing history managing server 500.

Examples of the related program list 401 include a list of serial programs which have same titles, a list of serial programs which have different titles, a list of programs in which the same (or related) character appears, a list of programs produced by the same (or related) production company or production staff, and the like. The related program list 401 may be provided by a content provider or set according to user's own preferences. This allows the related program list 401 to be provided with higher accuracy to suit more the user's preferences, unlike a list prepared by statistically extracting related programs. FIG. 2 illustrates the related program list 401 that comprises four lists, each list having a unique name different from the others. The related program list 401 is not, however, limited to this configuration; alternatively, the related program list 401 may comprise only one list.

The viewing history managing server 500 prepares a check list 501 by collating a list of the viewed programs acquired from the history collecting server 300 with the related program list 401 acquired from the related program list managing server 400. The check list 501 provides a list of information (first information) for allowing identification of whether each of the related programs listed on the related program list 401 has been viewed.

In the embodiment, the check list 501 further includes information that indicates a viewing mode in which the related programs listed on the related program list 401 have been viewed. Examples of the viewing modes include a viewing mode in which the program is viewed live (on a real-time basis), a viewing mode in which a recorded program is viewed, a viewing mode in which a program is viewed as VOD content, a viewing mode in which a program is viewed in a theater, a viewing mode in which a program recorded in a recording medium such as a digital versatile disc (DVD) is viewed, and a viewing mode in which a program uploaded to a web site is viewed.

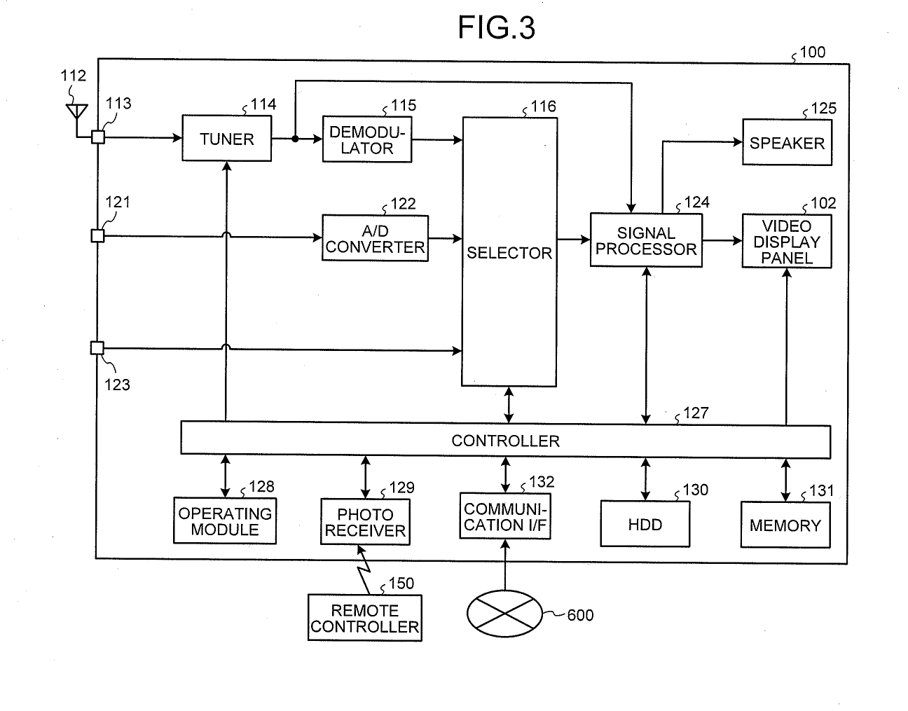

The following describes an exemplary internal configuration of the television 100 with reference to FIG. 3. The television 100 has recording and playing back functions, a content playing back function of playing back VOD content, and other functions.

As illustrated in FIG. 3, the television 100 comprises an antenna 112, an input terminal 113, a tuner 114, and a demodulator 115. The antenna 112 receives a broadcast wave of digital broadcasting and supplies broadcast signals of the broadcast wave to the tuner 114 via the input terminal 113.

The tuner 114 selects a broadcast signal of a desired channel from among the broadcast signals of digital broadcasting applied thereto. The broadcast signal output from the tuner 114 is supplied to the demodulator 115. The demodulator 115 generates a video signal and an audio signal in a digital format by performing demodulation processing on the broadcast signal, and then supplies the video and audio signals to a selector 116 to be described later.

The television 100 further comprises input terminals 121 and 123, an A/D converter 122, a signal processor 124, a speaker 125, and a video display panel 102. The video display panel 102 is one example of a “display”.

The input terminal 121 receives inputs of a video signal and an audio signal in an analog format from outside. The input terminal 123 receives inputs of a video signal and an audio signal in the digital format from outside. The A/D converter 122 converts the video signal and the audio signal in the analog format supplied from the input terminal 121 to corresponding digital signals and supplies the resultant digital signals to the selector 116.

The selector 116 selects one out of a plurality of digital signals supplied from the demodulator 115, the A/D converter 122, and the input terminal 123 and supplies the digital signal to the signal processor 124.

The signal processor 124 performs predetermined signal processing and scaling processing on the video signal input thereto and supplies a resultant video signal to the video display panel 102. In addition, the signal processor 124 converts the audio signal in the digital format into an audio signal in the analog format by performing predetermined signal processing on the audio signal in the digital format input thereto. The signal processor 124 then outputs the audio signal in the analog format after the conversion to the speaker 125.

Additionally, the signal processor 124 generates, for example, an on-screen display (OSD) signal for providing an OSD interface that uses the video display panel 102.

The speaker 125 outputs audio based on the audio signal supplied from the signal processor 124.

The video display panel 102 comprises, for example, a flat panel display such as a liquid crystal display or a plasma display. The video display panel 102 outputs video based on the video signal supplied from the signal processor 124.

The television 100 further comprises a controller 127, an operating module 128, a photo receiver 129, a hard disk drive (HDD) 130, a memory 131, and a communication I/F 132.

The controller 127 generally controls various operations in the television 100. The controller 127 is a microprocessor that incorporates a central processing unit (CPU) and the like. The controller 127 receives inputs of operation information from the operating module 128, and a remote controller 150 via the photo receiver 129. Based on the operation information from the operating module 128 and the remote controller 150, the controller 127 controls each element of the television 100.

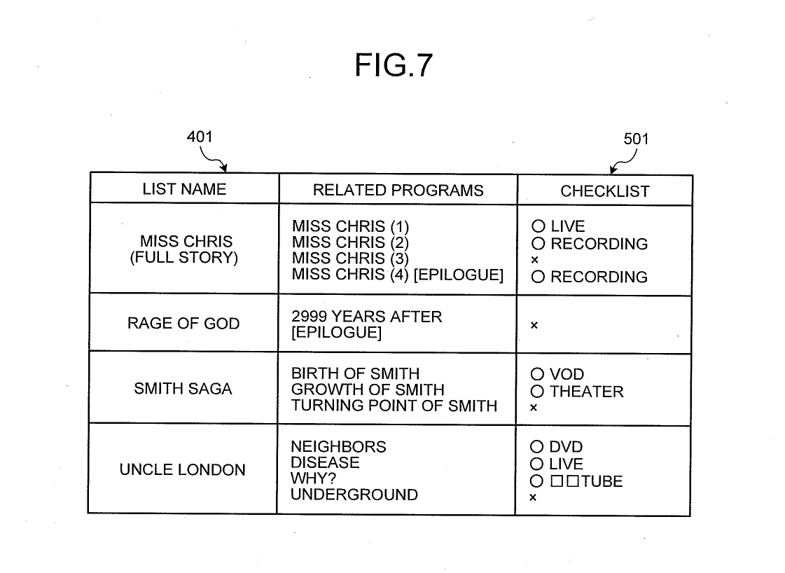

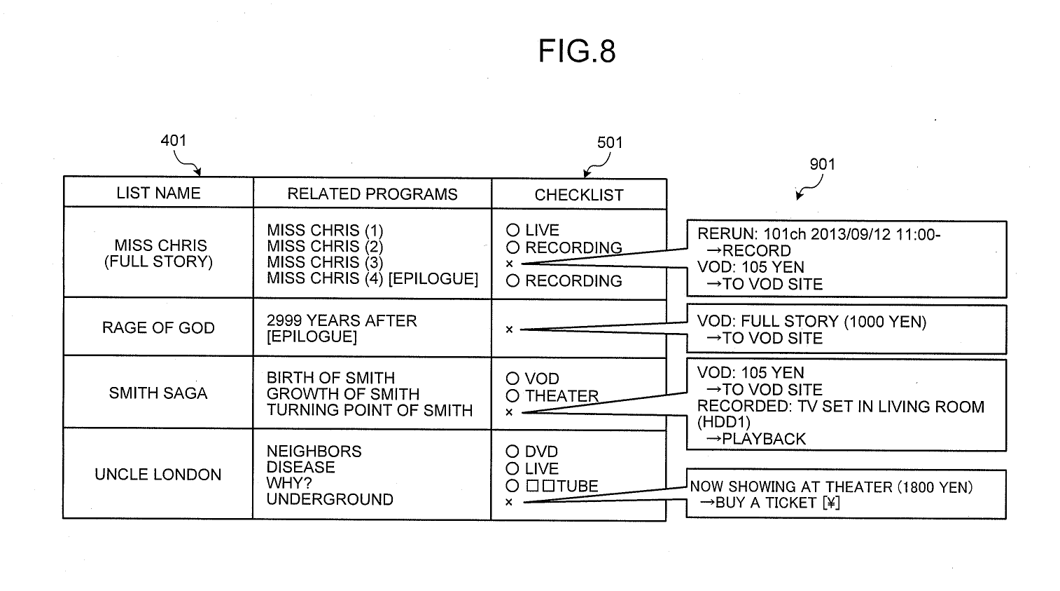

The controller 127 uses the memory 131 when performing the above-described control. The memory 131 mainly has a read only memory (ROM), a random access memory (RAM), and a non-volatile memory. The ROM stores therein various types of control programs executed by the CPU built into the controller 127. The RAM is used as a work area by the CPU. The non-volatile memory stores therein, for example, various types of setup information and control information. Examples of the control programs stored in the ROM include a display control program for displaying the related program list 401 and the check list 501 simultaneously on the video display panel 102 (see FIG. 7 to be described later) and displaying recommended information, together with the related program list 401 and the check list 501, on the video display panel 102 (see FIG. 8 to be described later).

The HDD 130 functions as a storage that records therein the digital signal selected by the selector 116. The HDD 130 stores therein recorded data, for example, recorded by the television 100.

The communication I/F 132 is connected to the network 600. This allows the television 100 to transmit various types of information such as the operation history and the viewing history of users, in addition to allowing the television 100 to receive various types of data such as programs and services from communication devices (e.g., various types of servers illustrated in FIG. 1) on the network 600 via the communication I/F 132.

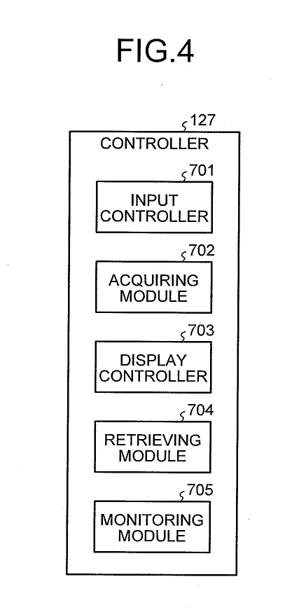

The following describes a functional configuration of the controller 127 with reference to FIG. 4.

As illustrated in FIG. 4, the controller 127 mainly comprises an input controller 701, an acquiring module 702, a display controller 703, a retrieving module 704, and a monitoring module 705. The acquiring module 702 is one example of a “processor”.

The input controller 701 is configured to receive operating inputs made by the user through the operating module 128, and from the remote controller 150 by way of the photo receiver 129.

The acquiring module 702 is configured to acquire various types of data provided by communication services on the network 600. For example, the acquiring module 702 is configured to be capable of acquiring the check list 501 from the viewing history managing server 500.

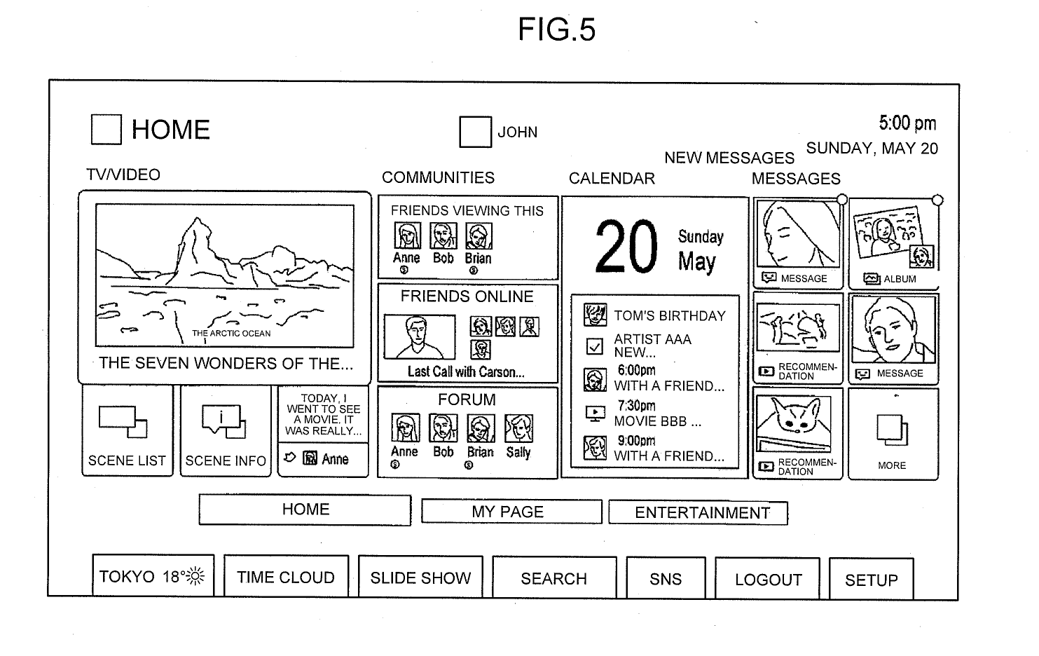

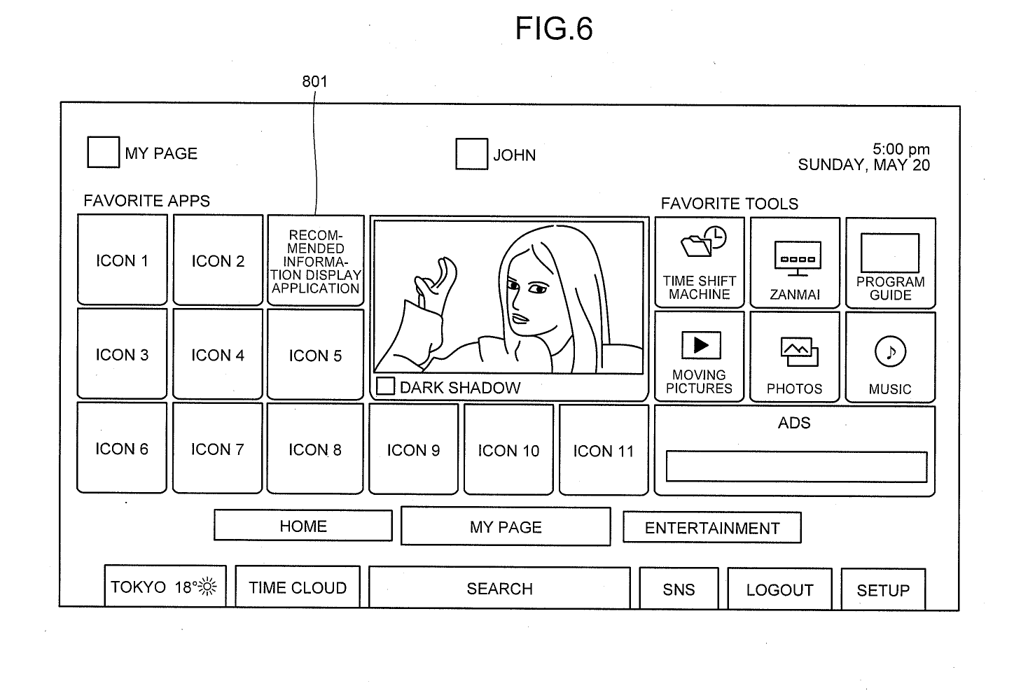

The display controller 703 is configured to control to display various types of information on the video display panel 102. For example, the display controller 703 is configured to be capable of controlling to display a cloud menu as illustrated in FIGS. 5 and 6 on the video display panel 102. The “cloud menu” as used herein refers to a menu screen that allows the user to select various types of cloud services offered by the television 100.

The cloud menu may, for example, be a home screen as illustrated in FIG. 5 or a my-page screen unique to a user as illustrated in FIG. 6. The my-page screen illustrated in FIG. 6 displays a button 801 that calls a recommended information display application. The recommended information display application refers to an application program corresponding to the above display control program for displaying the related program list 401 and the check list 501 simultaneously on the video display panel 102 (see FIG. 7 to be described later) and displaying the recommended information, together with the related program list 401 and the check list 501, on the video display panel 102 (see FIG. 8 to be described later).

In the embodiment, the display controller 703 is configured to be capable of simultaneously displaying the related program list 401 and the check list 501 on the video display panel 102 as illustrated in FIG. 7. Specifically, the display controller 703 is configured to be capable of displaying the related program list 401 and the check list 501 on the video display panel 102 in a display mode that allows identification of whether each of the related programs listed on the related program list 401 has been viewed. In the example illustrated in FIG. 7, the “◯” mark in the check list 501 indicates a viewed program being already viewed and the “x” mark in the check list 501 indicates a program that has not been viewed yet (unviewed program).

Additionally, in the embodiment, when the related program list 401 includes unviewed programs that have not been viewed yet and the number of the unviewed programs or a proportion of the unviewed programs to the programs in the related program list 401 is smaller than a threshold, the display controller 703 is configured to display the unviewed programs as recommendation for the user. Specifically, the retrieving module 704 is configured to retrieve recommended information related to the unviewed programs. The recommended information presents, for example, a future broadcast schedule of the unviewed programs and how to view the unviewed programs. Additionally, as illustrated in FIG. 8, for example, the display controller 703 is configured to be capable of displaying on the video display panel 102 a result of the retrieval performed by the retrieving module 704 as the recommended information, together with the related program list 401 and the check list 501. In the example illustrated in FIG. 8, the recommended information is displayed inside balloons denoted by 901. Data items to be retrieved by the retrieving module 704 include, not only content owned by the user and saved in the television 100 and various types of storages including a home network, a recorder, and an external HDD, but also paid content such as the VOD, content to be broadcast soon, and movies screened in theaters.

In addition, in the embodiment, as illustrated, for example, in FIGS. 7 and 8, the display controller 703 is configured to display information (second information) that allows identification of a viewing mode in which each of the viewed programs has been viewed, together with the related program list 401 and the check list 501 on the video display panel 102. In the example illustrated in FIGS. 7 and 8, the viewing modes are indicated by character strings of “Live”, “Recording”, “VOD”, “Theater”, “DVD”, and “□□TUBE” displayed beside the “◯” mark or the “x” mark in the check list 501. In the example illustrated in FIG. 8, similarly to the example illustrated in FIG. 7, the “◯” mark in the check list 501 indicates the viewed program and the “x” mark in the check list 501 indicates the unviewed program.

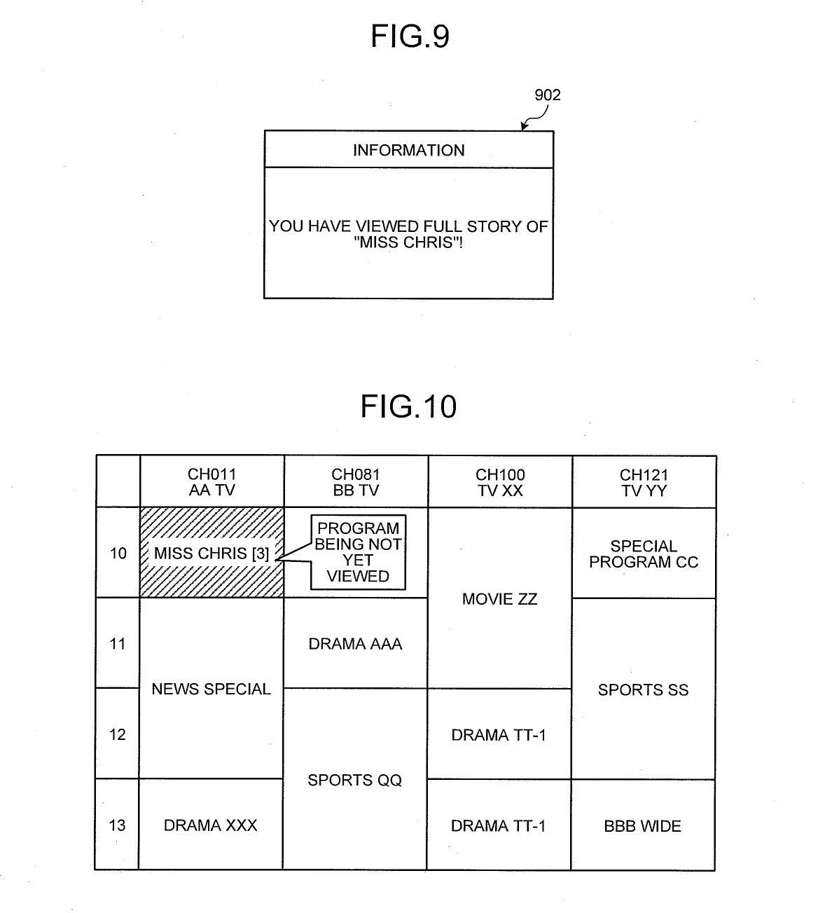

In the embodiment, the monitoring module 705 is configured to monitor whether the check list 501 satisfies a predetermined condition. When the check list 501 satisfies the predetermined condition, the display controller 703 is configured to display a message that corresponds to the satisfied condition on the video display panel 102. For example, when all of the programs included in the related program list 401 have been viewed, the display controller 703 is configured to display a screen 902 that includes a message relating to the related program list 401 as illustrated in FIG. 9 on the video display panel 102. The screen 902 illustrated in FIG. 9 exemplarily displays a message notifying the user that all programs listed under the name “Miss Chris” in the related program list 401 illustrated in FIGS. 7 and 8 have been viewed. As described above, the predetermined condition may include, for example, a condition that all programs in a serial listed in the related program list 401 have been viewed. This is, however, not the only possible condition.

In the embodiment, the display controller 703 is also configured to be capable of displaying a broadcast program guide that presents a list of broadcast programs on the video display panel 102. If any of the unviewed programs included in the related programs listed in the related program list 401 exists in the broadcast program guide, the display controller 703 is configured to be capable of displaying on the video display panel 102 the broadcast program guide in a display mode that allows the unviewed programs to be distinguished from other programs included in the broadcast program guide as illustrated, for example, in FIG. 10.

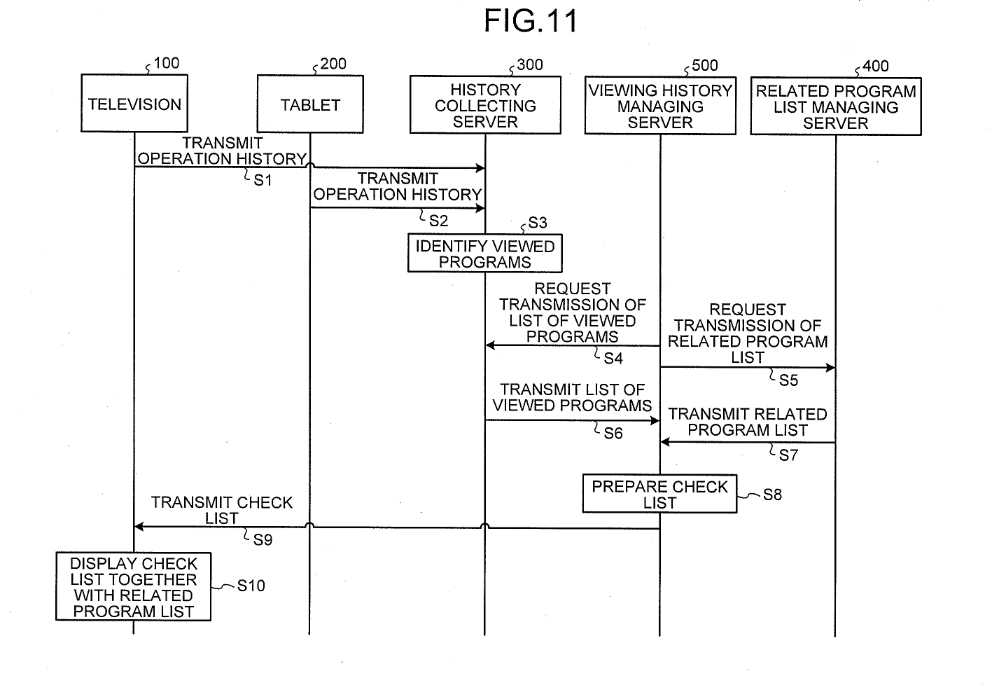

The following describes exemplary steps performed by the entire program recommendation system 1000 to display the related program list 401 and the check list 501 on the television 100 in the embodiment with reference to FIG. 11.

As illustrated in FIG. 11, at S1, the television 100 first transmits the operation history of the user to the history collecting server 300. At S2, the tablet 200 transmits the operation history of the user to the history collecting server 300. It is noted that the steps at S1 and S2 may be performed in reverse or simultaneously.

At S3, the history collecting server 300 identifies the viewed programs that have been viewed or played back by the users of the television 100 and the tablet 200 based on the operation history received from the television 100 and the tablet 200, and the program information DB 302 that the history collecting server 300 has.

At S4, the viewing history managing server 500 requests the history collecting server 300 to transmit a list of the viewed programs. At S5, the viewing history managing server 500 requests the related program list managing server 400 to transmit the related program list 401. It is noted that the steps at S4 and S5 are performed when, for example, the user presses the button 801 on the my-page screen (see FIG. 6) to thereby invoke the recommended information display application. It is further noted that the steps at S4 and S5 may be performed in reverse or simultaneously.

At S6, the history collecting server 300 transmits the list of the viewed programs to the viewing history managing server 500. At S7, the related program list managing server 400 transmits the related program list 401 to the viewing history managing server 500. It is noted that the step at S6 may be performed before the step at S5 or after the step at S7, as long as the step at S6 is performed after the step at S4. Similarly, the step at S7 may be performed before the steps at S4 and S6, as long as the step at S7 is performed after the step at S5.

At S8, the viewing history managing server 500 prepares the check list 501 by collating the list of the viewed programs acquired from the history collecting server 300 with the related program list 401 acquired from the related program list managing server 400.

At S9, the viewing history managing server 500 transmits the check list 501 to the television 100. At S10, the television 100 displays on the video display panel 102 the check list 501 received from the viewing history managing server 500, together with the related program list 401 (see, for example, FIG. 7).

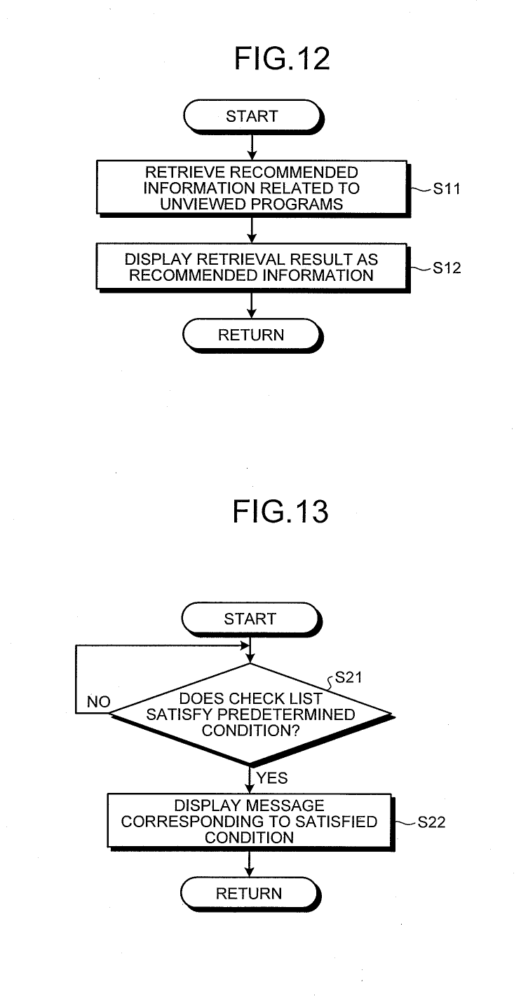

The following describes exemplary steps performed by the television 100 in the embodiment to display the recommended information on the television 100 with reference to FIG. 12.

As illustrated in FIG. 12, at S11, the retrieving module 704 retrieves the recommended information related to the unviewed programs, and then S12 is performed.

At S12, the display controller 703 displays on the video display panel 102 a result of the retrieval performed at S11 as the recommended information (see, for example, FIG. 8). Then, these steps are repeated.

The following describes, with reference to FIG. 13, exemplary steps performed by the television 100 in the embodiment to display on the television 100 the message indicating that the check list 501 satisfies a predetermined condition.

As illustrated in FIG. 13, at S21, the monitoring module 705 determines whether the check list 501 satisfies the predetermined condition. This step is repeated until the monitoring module 705 determines that the check list 501 satisfies the predetermined condition. When the monitoring module 705 determines that the check list 501 satisfies the predetermined condition at S21, S22 is performed.

At S22, the display controller 703 displays a message corresponding to the satisfied condition on the video display panel 102 (see, for example, FIG. 9). Then, these steps are repeated.

As described heretofore, in the embodiment, the acquiring module 702 acquires the checklist 501 from the viewing history managing server 500. The check list 501 provides a list that identifies whether each of the related programs listed on the related program list 401 has been viewed. The display controller 703 displays the check list 501 together with the related program list 401 on the video display panel 102 (see, for example, FIG. 7). Thus, the related program list 401 and the check list 501 displayed simultaneously on the video display panel 102 allow at-a-glance determination of whether each of the related programs has been viewed.

In the embodiment, the retrieving module 704 retrieves the recommended information (the first information) related to the unviewed programs and the display controller 703 displays the recommended information together with the related program list 401 and the check list 501 on the video display panel 102 (see, for example, FIG. 8). This enables at-a-glance determination of the recommended information related to the unviewed programs listed on the related program list 401 (e.g., a future broadcast schedule of the unviewed programs and how to view the unviewed programs).

In addition, in the embodiment, the display controller 703 displays on the video display panel 102 the information (the second information) that indicates a viewing mode in which the viewed program has been viewed, together with the related program list 401 and the check list 501 (see, for example, FIGS. 7 and 8). This allows at-a-glance determination of a viewing mode in which a viewed program listed on the related program list 401 has been viewed.

In the embodiment, the monitoring module 705 monitors whether the check list 501 satisfies the predetermined condition and, when the check list 501 satisfies the predetermined condition, the display controller 703 displays a message that corresponds to the satisfied condition on the video display panel 102 (see, for example, FIG. 9). This facilitates notification to the user of the check list 501 satisfying the predetermined condition such as a condition that all programs in a serial listed in the related program list 401 have been viewed.

Additionally, in the embodiment, if any of the unviewed programs listed on the related program list 401 exists in the broadcast program guide, the display controller 703 displays the broadcast program guide on the video display panel 102 in a display mode that allows the unviewed programs to be distinguished from other programs included in the broadcast program guide (see, for example, FIG. 10). This enables at-a-glance determination of whether any of the unviewed programs exists in the broadcast program guide.

The display control program executed by the controller 127 of the television 100 in the embodiment is stored in, for example, the ROM of the memory 131. The display control program is provided as a computer program product recorded in a computer-readable recording medium such as a compact disc read only memory (CD-ROM), a flexible disk (FD), a compact disc recordable (CD-R), or a digital versatile disc (DVD), as an installable or executable file. The display control program may still be provided or distributed over a network such as the Internet as a computer program product stored in a computer connected to the network. Furthermore, the display control program may even be provided as a computer program product previously incorporated in, for example, a ROM.

The display control program in the embodiment has a modular configuration comprising the above-described functional units (the input controller 701, the acquiring module 702, the display controller 703, the retrieving module 704, and the monitoring module 705). Each functional unit is generated as actual hardware on, for example, the RAM of the memory 131 as a result of the CPU of the controller 127 loading the display control program from, for example, the ROM of the memory 131 and executing the loaded program.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of displaying a program list using an electronic device comprising:
acquiring a first list comprising a plurality of first programs;
acquiring first information indicative of whether each of the first programs in the first list has been viewed; and
displaying on a display simultaneously the first programs and the first information.

2. The method of claim 1, further comprising displaying, when a number of the first programs that have not been viewed yet or a proportion of the first programs that have not been viewed yet is smaller than a threshold, displaying the first programs that have not been viewed yet as a recommendation, wherein
when a number of the first programs that have not been viewed yet or a proportion of the first programs that have not been viewed yet is not smaller than a threshold, the first programs that have not been viewed yet are not displayed as a recommendation.

3. The method of claim 1, wherein the displaying comprises displaying on the display simultaneously second information in addition to displaying the first programs and the first information, the second information indicative of a viewing mode in which the first programs that have been viewed are viewed.

4. The method of claim 1, further comprising displaying, when all of the first programs have been viewed, a message relating to the first list on the display.

5. The method of claim 1, further comprising displaying, when any of the first programs that have not been viewed yet exists in a broadcast program guide different from the first list, the broadcast program guide on the display in a display mode configured to at least allow the first programs that have been viewed to be distinguished from other programs in the broadcast program guide.

6. An electronic device comprising:
a processor configured to acquire a first list and first information, the first list comprising a plurality of first programs, the first information indicative of whether each of the first programs in the first list has been viewed; and
a display controller configured to simultaneously display on a display the first programs and the first information.

7. The electronic device of claim 6, wherein, when a number of the first programs that have not been viewed yet or a proportion of the first programs that have not been viewed yet is smaller than a threshold, the display controller is configured to display on the display the first programs that have not been viewed yet as a recommendation, and
when a number of the first programs that have not been viewed yet or a proportion of the first programs that have not been viewed yet is not smaller than a threshold, the display controller is configured not to display on the display the first programs that have not been viewed yet as a recommendation.

8. The electronic device of claim 6, wherein the display controller is configured to display on the display simultaneously second information in addition to displaying the first programs and the first information, the second information indicative of a viewing mode in which the first programs that have been viewed are viewed.

9. The electronic device of claim 6, wherein, when all of the first programs have been viewed, the display controller is configured to display on the display a message relating to the first list.

10. The electronic device of claim 6, wherein, when any of the first programs that have not been viewed yet exists in a broadcast program guide different from the first list, the display controller is configured to display on the display the broadcast program guide in a display mode configured to at least allow the first programs that have been viewed to be distinguished from other programs in the broadcast program guide.

11. A computer program product having a non-transitory computer readable medium including programmed instructions, wherein the instructions, when executed by a computer, cause the computer to perform:
acquiring a first list comprising a plurality of first programs;
acquiring first information indicative of whether each of the first programs in the first list has been viewed; and
displaying on a display simultaneously the first programs and the first information.

12. The computer program product of claim 11, wherein the instructions cause the computer to further perform displaying, when a number of the first programs that have not been viewed yet or a proportion of the first programs that have been not viewed yet is smaller than a threshold, the first programs that have not been viewed yet as a recommendation, wherein
when a number of the first programs that have not been viewed yet or a proportion of the first programs that have not been viewed yet is not smaller than a threshold, the first programs that have not been viewed yet are not displayed as a recommendation.

13. The computer program product of claim 11, wherein the displaying comprises displaying on the display simultaneously second information in addition to displaying the first programs and the first information, the second information indicative of a viewing mode in which the first programs that have been viewed are viewed.

14. The computer program product of claim 11, wherein the instructions cause the computer to further perform displaying, when all of the first programs have been viewed, a message relating to the first list on the display.

15. The computer program product of claim 11, wherein the instructions cause the computer to further perform displaying, when any of the first programs that have not been viewed yet exists in a broadcast program guide different from the first list, the broadcast program guide on the display in a display mode configured to at least allow the first programs that have been viewed to be distinguished from other programs in the broadcast program guide.
